(19) United States
(12) Patent Application Publication
(10) Pub. No.: US 2007/0164809 A1
(43) Pub. Date: Jul. 19, 2007

(54) Voltage generation circuit and semiconductor integrated circuit device

(76) Inventors: Keiko Fukuda, Nanae (JP); Mitsuru Hiraki, Tokyo (JP); Masashi Horiguchi, Tokyo (JP); Takesada Akiba, Nanae (JP); Shuzo Ichiki, Tokyo (JP); Hideki Tsunoda, Tokyo (JP); Akihiro Kitagawa, Tokyo (JP)

Correspondence Address: MILES & STOCKBRIDGE PC, 1751 PINNACLE DRIVE, SUITE 500, MCLEAN, VA, 22102-3833, US

(21) Appl. No.: 10/584,395

(22) PCT Filed: Dec. 2, 2004
(86) PCT No.: PCT/JP04/17910

§ 371 Date: Jun. 23, 2006

(30) Foreign Application Priority Data
Dec. 24, 2003 (JP) 2003-426796

(51) Int. Cl. G05F 1/10

(52) U.S. Cl. 327/539

(57) ABSTRACT

A constant current is formed by supplying voltage differences between bases and emitters of a first transistor which allows a first current to flow in the emitter thereof and a second transistor which allows a second current having a current density larger than a current density of the first transistor to flow in an emitter thereof to a first resistance. A second resistance is provided on a ground potential side of a circuit in series with the first resistance. A third and a fourth resistances are provided between collectors and the power supply voltages of the first transistor and the second transistor. Both collector voltages of the first and second transistors are supplied to a differential amplifier circuit having the CMOS constitution thus forming an output voltage and, at the same time, the output voltage is supplied to bases of the first transistor and the second transistor in common.

### TECHNICAL FIELD

The present invention relates to a voltage generating circuit and a semiconductor integrated circuit device, and more particularly to a technique which is effectively applicable to a reference voltage generating circuit which makes use of a silicon band gap and a semiconductor integrated circuit device which incorporates the reference voltage generating circuit therein.

### BACKGROUND OF THE INVENTION

An example of a reference voltage generating circuit which includes a reference voltage generating part based on a band gap of a PNP bipolar transistor is described in Journal of solid-state circuit, vol. SC-8, No. 6, 1973, pp. 222-226. Further, an example of a reference voltage generating circuit which includes a reference voltage generating part based on a band gap of a NPN bipolar transistor is described in U.S. Pat. No. 3,887,863 and Journal of solid-state circuit, vol. SC-9, No. 12, 1974, pp. 388-393.

[Non-Patent Document 1]

Journal of solid-state circuit, vol. SC-8, No. 6, 1973, pp. 222-226.

[Non-Patent Document 2]

Journal of solid-state circuit, vol. SC-9, No. 12, 1974, pp. 388-393.

[Patent Document 1]

U.S. Pat. No. 3,887,863

### DISCLOSURE OF THE INVENTION

In the circuit described in the above-mentioned non-patent document 1, the circuit is largely influenced by offset irregularities of an operational amplifier which performs an amplifying operation and a feedback operation and hence, the circuit requires a trimming circuit for correcting the offset irregularities. Particularly, when the circuit is mounted on a semiconductor integrated circuit device, it is difficult to ensure the easy-to-use property. Further, in the circuit described in the non-patent document 2, transistors which are used in the circuit are formed by a process of a bipolar transistor and are operated using two power sources of positive and negative polarities and hence, the mounting of the circuit on a semiconductor integrated circuit device which is formed by a CMOS process is not suitable.

Accordingly, it is an object of the present invention to provide a voltage generating circuit suitable for CMOS process and a semiconductor integrated circuit device which mounts the voltage generating circuit thereon. The above-mentioned and other objects and novel features of the present invention will become apparent from the description of this specification and attached drawings.

To briefly explain the summary of typical inventions out of inventions disclosed in this application, they are as follows. That is, a voltage generating circuit includes a first transistor which allows a first current to flow in an emitter thereof and a second transistor which allows a second current having a current density larger than a current density of the first current of the first transistor to flow in an emitter thereof, voltage differences between bases and the emitters of the first transistor and the second transistor are allowed to flow in a first resistance to form a constant current, a second resistance is provided to a ground potential side of the circuit in series with the first resistance, a third resistance and a fourth resistance are provided between collectors of the first transistor and the second transistor and a power source voltage, both collector voltages of the first and second transistors are supplied to a differential amplifier circuit having the CMOS constitution to form an output voltage, and the output voltage is supplied to the bases of the first transistor and the second transistor in common.

### BRIEF EXPLANATION OF DRAWINGS

FIG. 1 is a circuit diagram showing one embodiment of a reference voltage generating circuit according to the present invention.

FIG. 2 is a characteristic chart for explaining the relationship between an offset input and an offset output of the reference voltage generating circuit according to the present invention.

FIG. 3 is an explanatory view of a layout showing one embodiment of an npn-type bipolar transistor and an n-channel MOSFET and a p-channel MOSFET which constitute a differential amplifier circuit used in the reference voltage generating circuit according to the present invention and the element structure in the layout.

FIG. 4 is an explanatory view of a layout showing another embodiment of an npn-type bipolar transistor and an n-channel MOSFET and a p-channel MOSFET which constitute a differential amplifier circuit used in the reference voltage generating circuit according to the present invention and the element structure in the layout.

FIG. 5 is an explanatory view of a layout showing still another embodiment of an npn-type bipolar transistor and an n-channel MOSFET and a p-channel MOSFET which constitute a differential amplifier circuit used in the reference voltage generating circuit according to the present invention and the element structure in the layout.

FIG. 6 is a layout view showing another embodiment of an npn-type bipolar transistor used in the reference voltage generating circuit according to the present invention.

FIG. 7 is a layout view showing another embodiment of an npn-type bipolar transistor used in the reference voltage generating circuit according to the present invention.

FIG. 8 is a layout view showing one embodiment of npn-type bipolar transistors Q1, Q2 used in the reference voltage generating circuit according to the present invention.

FIG. 9 is a layout view showing another embodiment of npn-type bipolar transistors Q1, Q2 used in the reference voltage generating circuit according to the present invention.

FIG. 10 is a layout view showing another embodiment of npn-type bipolar transistors Q1, Q2 used in the reference voltage generating circuit according to the present invention.

FIG. 11 is a layout view showing another embodiment of npn-type bipolar transistors Q1, Q2 used in the reference voltage generating circuit according to the present invention.

FIG. 12 is a circuit diagram showing one embodiment of a CMOS differential amplifier circuit used in the reference voltage generating circuit according to the present invention.

FIG. 13 is a circuit diagram showing another embodiment of a CMOS differential amplifier circuit used in the reference voltage generating circuit according to the present invention.

FIG. 14 is a circuit diagram showing one embodiment of the reference voltage generating circuit according to the present invention.

FIG. 15 is a circuit diagram showing one embodiment of the reference voltage generating circuit according to the present invention.

FIG. 16 is a circuit diagram showing one embodiment of a power source circuit using the reference voltage generating circuit according to the present invention.

FIG. 17 is a circuit diagram showing another embodiment of the reference voltage generating circuit according to the present invention.

FIG. 18 is a whole block diagram showing one embodiment of a semiconductor integrated circuit device according to the present invention.

FIG. 19 is a whole block diagram showing another embodiment of a semiconductor integrated circuit device according to the present invention.

FIG. 20 is a block diagram for explaining an application example of the reference voltage generating circuit according to the present invention.

FIG. 21 is a block diagram for explaining another application example of the reference voltage generating circuit according to the present invention.

FIG. 22 is an element structural view showing one embodiment of a resistance element mounted in the semiconductor integrated circuit device according to the present invention.

FIG. 23 is an element structural view showing one embodiment of a capacitance element mounted in the semiconductor integrated circuit device according to the present invention.

FIG. 24 is a circuit diagram showing one example of a conventional reference voltage generating circuit.

### BEST MODE FOR CARRYING OUT THE INVENTION

The present invention is explained in conjunction with attached drawings for explaining the present invention in more detail.

FIG. 1 shows a circuit diagram showing one embodiment of a reference voltage generating circuit according to the present invention. Respective circuit elements shown in the drawing are formed on one semiconductor substrate made of mono-crystal silicon or the like together with other circuit elements not shown in the drawing using a known manufacturing technique of a CMOS integrated circuit.

The reference voltage generating circuit of this embodiment is constituted of a band gap generating part and an amplifying/feedback part. The band gap generating part is constituted of a pair of npn-type bipolar transistors Q1, Q2 and resistances R1 to R4. With respect to the above-mentioned transistors Q1, Q2, a size of the transistors Q2 is set n times as large as a size of the transistor Q1. That is, in this embodiment, By allowing the above-mentioned transistor Q2 to have the large size, when the same current is made to flow in the transistors Q2 and Q1, an emitter current density of the transistor Q1 is set to a value which is n times as large as an emitter current density of the transistor Q2.

Corresponding to the above-mentioned emitter current density difference between the transistors, with respect to base-emitter voltages Vbe1, Vbe2 of the transistors Q1, Q2, the base-emitter voltage Vbe1 of the transistor Q1 is set larger than the base-emitter voltage Vbe2 of the transistor Q2 by a constant voltage ΔVbe corresponding to a silicon band gap. Using bases of the transistors Q1, Q2 in common, one end of a resistance R3 is connected to an emitter of the transistor Q2 and another end of the resistance R3 is connected to an emitter of the above-mentioned transistor Q1 and hence, the above-mentioned constant voltage ΔVbe is applied to both ends of the resistance R3 whereby a constant current such as ie2 is generated. A resistance R4 is provided between the emitter of the above-mentioned transistor Q1 and a ground potential VSS of the circuit and hence, a reference voltage Vref is generated from the bases of the transistors Q1, Q2.

Although not particularly limited, between collectors of the above-mentioned transistors Q1, Q2 and a power source voltage VCC, resistances R1, R2 which are configured to have the same resistance value are provided. Then, collector voltages of the transistors Q1, Q2 are supplied to a positive-phase input (+) and a negative-phase input (−) of a differential amplifier circuit AMP having the CMOS constitution, wherein the collector voltages are amplified and are fed back by the differential amplifier circuit AMP. That is, an output signal of the above-mentioned differential amplifier circuit AMP is outputted as a reference voltage Vref and, at the same time, is fed back to the bases of the above-mentioned transistors Q1, Q2.

The manner of operation of the above-mentioned band gap circuit is as follows. The base-emitter voltage Vbe of the bipolar transistor has characteristics having a negative voltage coefficient with respect to temperature. By correcting the base-emitter voltage Vbe with a voltage difference ΔV of the base-emitter voltages Vbe1, Vbe2 having positive voltage coefficients with respect to temperature, it is possible to obtain the reference voltage Vref which is not dependent on temperature. The above-mentioned transistors Q1, Q2 shown in FIG. 1 are bipolar transistors which have different sizes from each other (n-times in area or number) as described above. By applying a common potential to the bases of the transistors Q1, Q2 and by applying a feedback using the CMOS differential amplifier circuit AMP such that the collector potentials of the transistors Q1, Q2 become equal, the reference voltage Vref is obtained.

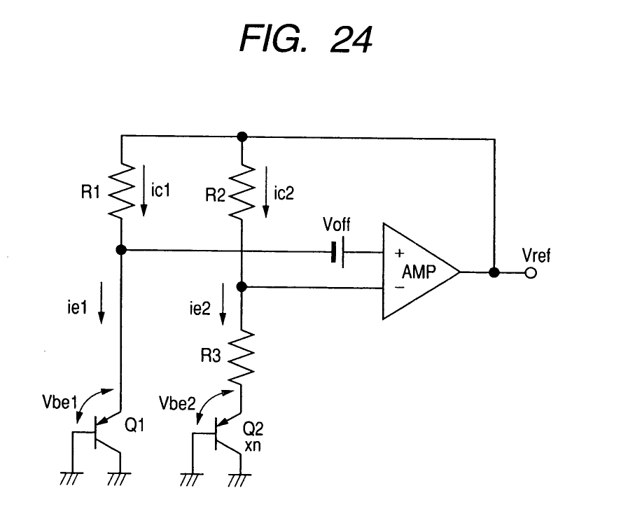

In the CMOS differential amplifier circuit used in the reference voltage generating circuit, an offset voltage is generated in an output of the circuit due to irregularities of a threshold value voltage Vth of a MOS transistor of an input part. For example, in the reference voltage generating circuit shown in FIG. 24 which uses the PNP bipolar transistor in diode connection as described in the above-mentioned non-patent document 1, the influence of an offset voltage Voff of the amplifier circuit AMP is large and hence, trimming is performed to obtain the reference voltage Vref with high accuracy.

The reference voltage Vref which is generated by the reference voltage generating circuit of this embodiment can be obtained by a following formula (1).
Vref=Vbel+ie·R4 (1)

Here, the above-mentioned emitter current ie is given by a following formula (2) based on the voltage difference ΔV of the base-emitter voltages Vbe1 and Vbe2 of the transistors Q1, Q2.
ie=ΔVbe/R3=kT/q·ln(n)/R3 (2)

The following formula (3) is obtained by substituting the above-mentioned formula (2) into the formula (1).

$$\begin{matrix}Vref = Vbe 1 + ( ie 1 + ie 2 ) \cdot R 4 \\ = Vbe 2 + 2 kT / q \cdot R 4 / R 3 \cdot ln\end{matrix} \qquad ( 3 )$$

By setting a resistance value of the resistance R4 such that the negative voltage coefficient of the first term of the formula (1) is canceled, it is possible to obtain the reference voltage which is not dependent on temperature. Here, in view of the formula (2), to obtain the voltage difference ΔVbe with high accuracy, it is important that an error of an emitter current is small. By selecting the resistances R3, R4 such that the negative voltage coefficient of the base-emitter voltage Vbe2 is canceled as expressed in the formula (3), it is possible to obtain the reference voltage having low temperature dependency.

In this embodiment, when the offset voltage of the CMOS differential amplifier circuit AMP is present, the offset voltage is generated at collector terminals of the bipolar transistors Q1, Q2 (corresponding to outputs of the bipolar transistors Q1, Q2 which have emitters thereof grounded) and hence, the influence of the offset voltage on the emitter current ie1 and ie2 is small. In this manner, the influence of the offset voltage generated by the differential amplifier circuit AMP having the CMOS constitution on the reference voltage Vref (1/gain of band gap generating part) can be made small.

To the contrary, in the reference voltage generating circuit used in the pnp bipolar transistor shown in FIG. 24, the reference voltage Vref is expressed by a following formula (4).
Vref=Vbe2+ie2·(R3+R2) =Vbe2+kT/q·(1+R2/R3)·ln(n) (4)

Here, by selecting resistance values of the resistances R3, such that the negative voltage coefficient of the Vbe2 can be canceled, it is possible to obtain the reference voltage having low temperature dependency. However, when the offset voltage Voff is present in the amplifier circuit AMP, the reference voltage Vref is expressed by a following formula (5).
Vref=Vbe2+(kT/qln(n)+Voff)·(1+R2/R3) (5)

Due to the above-mentioned formula (5), the offset voltage Voff is amplified based on a gain which is determined by a R2/R3 ratio. As a result, due to the influence of the offset voltage, the emitter current value is erroneously corrected by a feedback operation thus generating an error (offset voltage) in the corrected voltage.

To compare the reference voltage generating circuit shown in FIG. 1 and the reference voltage generating circuit shown in FIG. 24, in the reference voltage generating circuit shown in FIG. 24, when the CMOS differential amplifier circuit AMP is used as in the case of the reference voltage generating circuit shown in FIG. 1, the influence of the offset voltage which is generated in the CMOS differential amplifier circuit AMP is amplified approximately 12 times, whereas the influence of the offset voltage can be reduced to approximately 0.7 times in the present invention. Accordingly, in the circuit of this embodiment shown in FIG. 1, while using the differential amplifier circuit AMP having the CMOS constitution which possesses the relatively large offset voltage Voff corresponding to the process irregularities of the elements, it is possible to generate the reference voltage Vref of high accuracy with small temperature dependency by reducing the influence of the offset voltage.

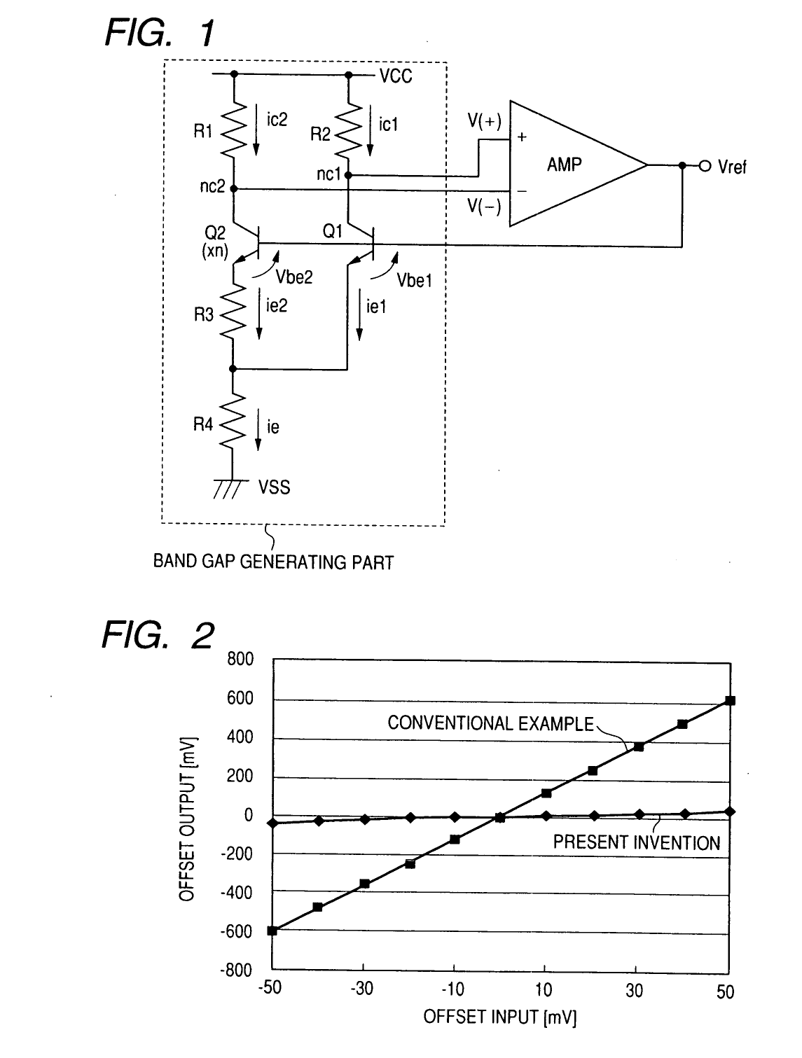

FIG. 2 shows a characteristic chart for explaining the relationship between an offset input and an offset output. With respect to the characteristic of the reference voltage generating circuit according to the invention of the present application (present invention), when the offset input falls within a range from −50 mV to +50 mV, the offset output is substantially maintained at the offset input as a constant value. To the contrary, in the above-mentioned reference voltage generating circuit shown in FIG. 24 which is provided for a comparison purpose, the offset output is increased to a value which falls within a range from −600 mV to +600 mV with respect to the same offset input and hence, trimming or the like is necessary for correcting such an offset output.

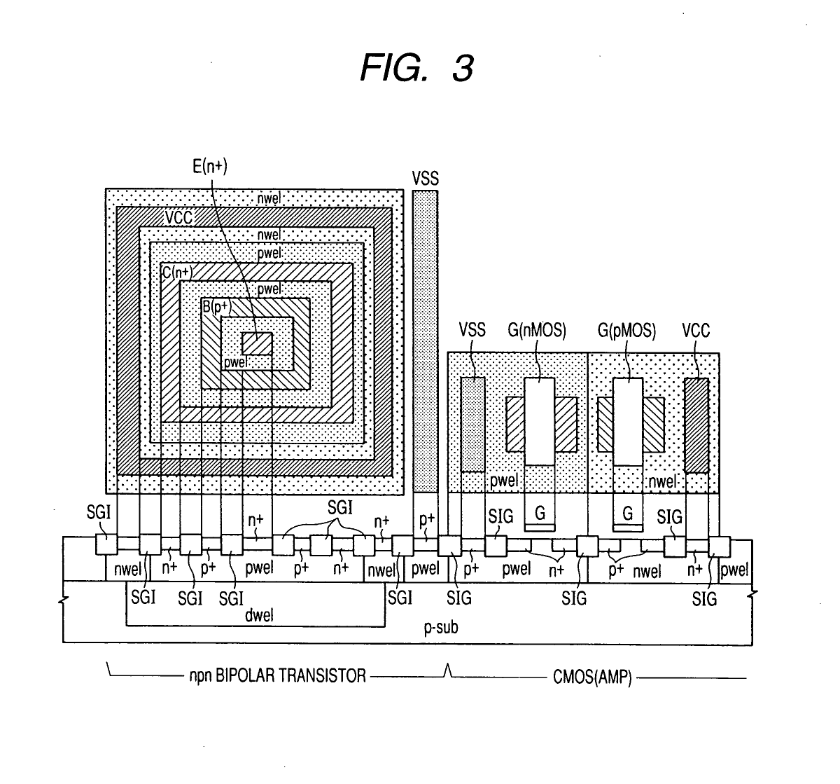

FIG. 3 shows an explanatory view of a layout showing one embodiment of an npn-type bipolar transistor and an n-channel MOSFET and a p-channel MOSFET which constitute a differential amplifier circuit AMP used in the reference voltage generating circuit according to the present invention and the element structure in the layout. In the drawing, the above-mentioned two MOSFETs and one transistor are exemplified as a typical example. The transistor indicates a unit transistor which constitutes a portion of the above-mentioned transistor Q1 or transistor Q2.

The npn-type bipolar transistor adopts, although not particularly limited, the lateral structure. On a p-type semiconductor substrate (p-sub), n-type deep wells (dwel) are formed. P-type wells pwel are formed on the deep wells dwel. In such a p-type well pwel, an n+ type emitter E (n+) is formed on a center portion thereof, and a p+ type base B (p+) is formed in a state that the base B (p+) surrounds the emitter P (n+). An n+ type collector C (n+) is formed in a state that the collector C (n+) further surrounds the base B (p+). The above-mentioned p-type well pwel is interposed between the above-mentioned emitter E and collector C and functions as a base region substantially. Between these semiconductor regions n+ and p+, an insulation layer SIG is formed to separate these semiconductor regions.

Although not particularly limited, around the above-mentioned p-type well pwel, an n-type well is formed to surround the p-type well pwel, wherein by bonding the n-type well to the above-mentioned deep wells dwel, a bias voltage such as a power source voltage VCC is applied via an n+ region which is formed on the n-type well. Accordingly, the respective semiconductor regions which constitute the above-mentioned npn-type bipolar transistor are electrically separated from the p-type semiconductor substrate (p-sub).

The n-channel MOSFET (nMOS) which constitutes the CMOS circuit adopts the n+ regions which are formed on the p-type well regions pwel formed on the above-mentioned semiconductor substrate p-sub as source and drain regions, and a gate electrode G (nMOS) is formed in a state that the gate electrode G (nMOS) is sandwiched between these source and drain by way of a gate insulation film. A ground potential VSS of the circuit is applied to the above-mentioned p-type well pwel from the p+ region as a bias voltage. The p-channel MOSFET (pMOS) adopts the p+ regions which are formed on the n-type well regions nwel formed on the above-mentioned semiconductor substrate p-sub as source and drain regions, and a gate electrode G (pMOS) is formed in a state that the gate electrode G (pMOS) is sandwiched between these source and drain by way of a gate insulation film. The power source voltage VCC is applied to the above-mentioned n-type well nwel from the n+ region as a bias voltage. To the above-mentioned semiconductor substrate p-sub, a bias voltage such as the ground potential VSS of the circuit is applied via the p-type well region pwel and the p+ region.

The p-type well region pwel and the n+ region which constitutes the source and the drain regions for forming the n-channel MOSFET constituting the above-mentioned CMOS circuit, and the p-type well region pwel and the n+ region which constitutes the emitter and the collector for forming the above-mentioned npn bipolar transistor are formed by the same process. Further, the p+ region which constitutes the source and drain regions of the p-channel MOSFET for constituting the CMOS circuit and the p+ region which constitutes the base for forming the above-mentioned npn bipolar transistor are formed by the same process.

The transistor Q1 (Q2) of the band gap generating part of this embodiment is a device which is formed by the CMOS process. By forming the transistors Q1, Q2, by the CMOS process in this manner, it is possible to form the reference voltage generating circuit by the CMOS process which is used for forming a digital CMOS circuit such as other microcomputer or the like formed on the same semiconductor substrate without using the bipolar process. By arranging a guard band or a guard ring which is constituted of the deep well dwel, the n-type well nwel and the n+ region around or between the bipolar part and the CMOS part, a substrate potential VSS of the semiconductor substrate p-sub is made stable thus suppressing the propagation of noises. By forming the npn bipolar transistor in the inside of the deep well dwel in this manner, it is possible to suppress the influence of noises which propagates from other circuit modules by way of the substrate p-sub.

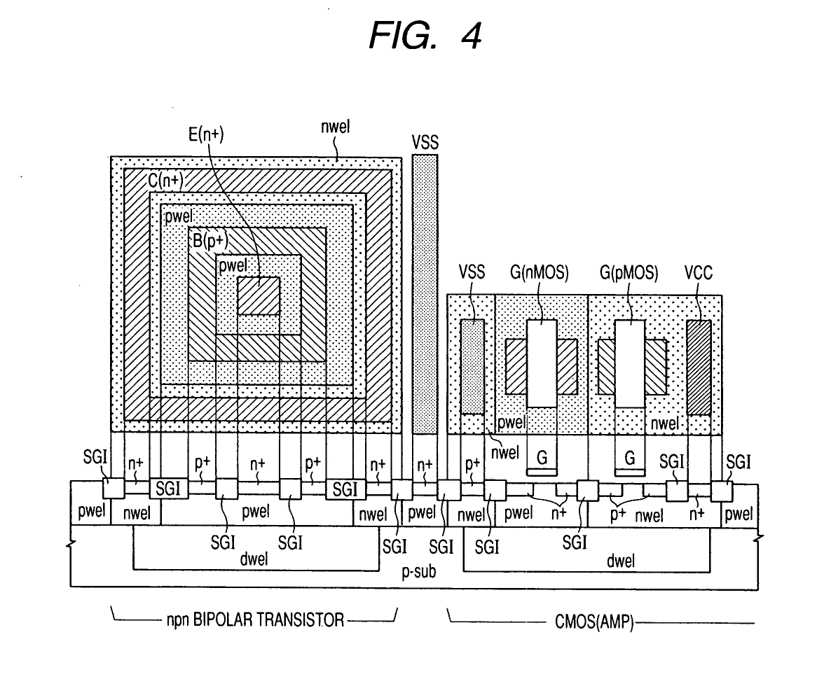

FIG. 4 is an explanatory view of a layout showing another embodiment of an npn-type bipolar transistor and an n-channel MOSFET and a p-channel MOSFET which constitute a differential amplifier circuit AMP used in the reference voltage generating circuit according to the present invention and the element structure in the layout. In the npn-type bipolar transistor of this embodiment, the collector is formed of the vertical structure using the n-type deep well dwel. In the same manner as the embodiment shown in FIG. 3, the base B (p+) is formed around the emitter E (n+) which constitutes the center, and the n-type well nwel and the n+ region for taking out the collector C (n+) are arranged in a state that the n-type well nwel and the n+ region surround the base B (p+). In this structure, the vertical structure is constituted of the emitter (n+ region), the base (p-type well pwel) and the collector (n-type deep well dwel).

The vertical npn bipolar transistor of this embodiment can obtain the high current amplification factor hfe of bipolar transistor and can obtain a high gain of the bipolar part compared to the lateral bipolar transistor shown in FIG. 3 and hence, an advantageous effect that the reference voltage of high accuracy can be generated by suppressing the influence of the offset voltage of the amplifying circuit as explained in conjunction with the above-mentioned embodiment shown in FIG. 1 can be further enhanced. Further, in this embodiment, the n-type deep well dwel is also provided to the CMOS circuit, and the p-type well pwel is surrounded by the n-type well nwel and hence, the p-type well pwel is electrically separated from the semiconductor substrate p-sub. Due to such a constitution, a potential of the p-type well pwel formed in the n-channel MOSFET can be freely determined without depending on the bias voltage VSS applied to the semiconductor substrate p-sub. Accordingly, this embodiment can cope with a digital circuit in which a bias VBB which is applied to the p-type well pwel is induced to a negative voltage.

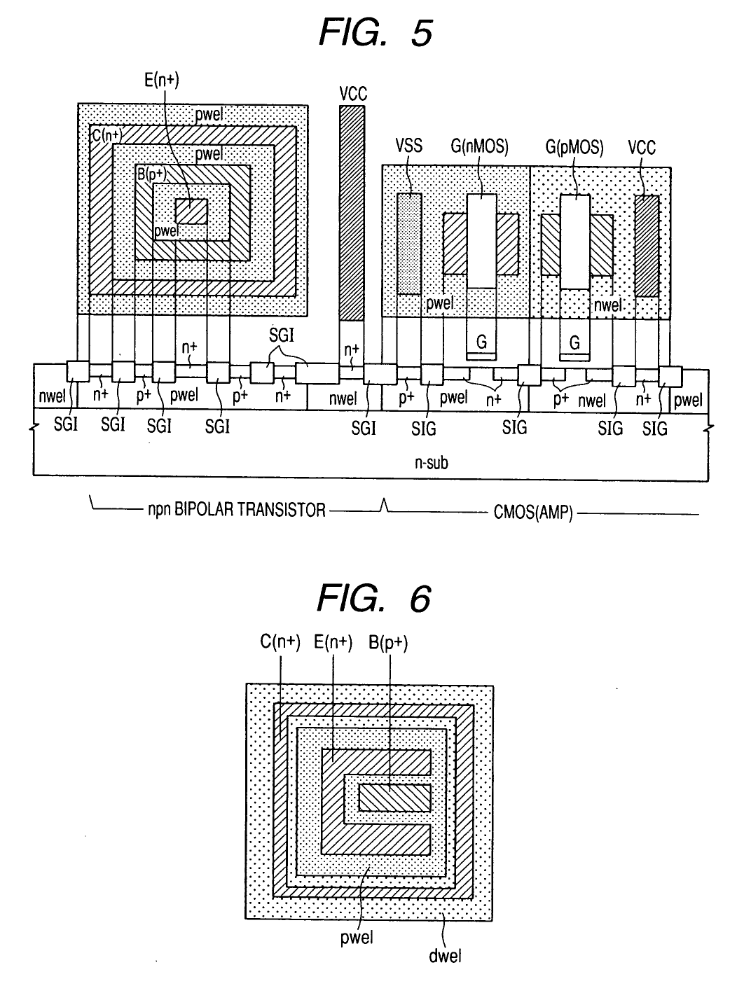

FIG. 5 is an explanatory view of a layout showing still another embodiment of an npn-type bipolar transistor and an n-channel MOSFET and a p-channel MOSFET which constitute a differential amplifier circuit AMP used in the reference voltage generating circuit according to the present invention and the element structure in the layout. In this embodiment, the n-type semiconductor substrate n-sub is used. When the n-type semiconductor substrate n-sub is used in this manner, different from the embodiment shown in FIG. 3, the npn bipolar transistor is constituted of the double well structure of CMOS. That is, the base B (p+), the emitter E (n+) and the collector C (n+) are formed of the p-type well pwel. In the same manner as the above-mentioned embodiment shown in FIG. 3, the base B and the collector C are arranged in a state that the base B and the collector C surround the emitter E which constitutes the center. This constitution can form the lateral npn-type bipolar transistor with the structure which does not form the deep well dwel in the embodiment shown in FIG. 3 (nMOS being formed in the inside of p-type well pwel and pMOS being formed in the inside of n-type well).

When the n-type semiconductor substrate n-sub is used in this embodiment, the deep well dwel for separating the substrate and the collector becomes no more necessary and hence, the transistor can be formed of the double well structure of CMOS. Accordingly, this embodiment can reduce some steps of the process.

The reference voltage generating circuit of this embodiment can obtain the reference voltage of high accuracy which is hardly influenced by the offset of the CMOS differential amplifier circuit. Since trimming which is performed for reducing the influence of the offset becomes unnecessary, this embodiment can provide a circuit which is advantageous as the reference voltage generating circuit of high accuracy which requires no trimming circuit for constituting a power source circuit of a ROM-less product such as a microcomputer for an air bag which makes trimming thereof difficult.

FIG. 6 is a layout view showing another embodiment of an npn-type bipolar transistor used in the reference voltage generating circuit according to the present invention. Although not particularly limited, in the same manner as the above-mentioned embodiment shown in FIG. 4, the collector C (n+) is formed in the vertical direction using the n-type deep well dwel (vertical structure). The emitter E (n+) is surrounded by the base B (p+) in a U-shape and the periphery of the base B (p+) is surrounded by the above-mentioned collector C (n+). This layout constitution is also applicable to the above-mentioned lateral transistor shown in FIG. 3.

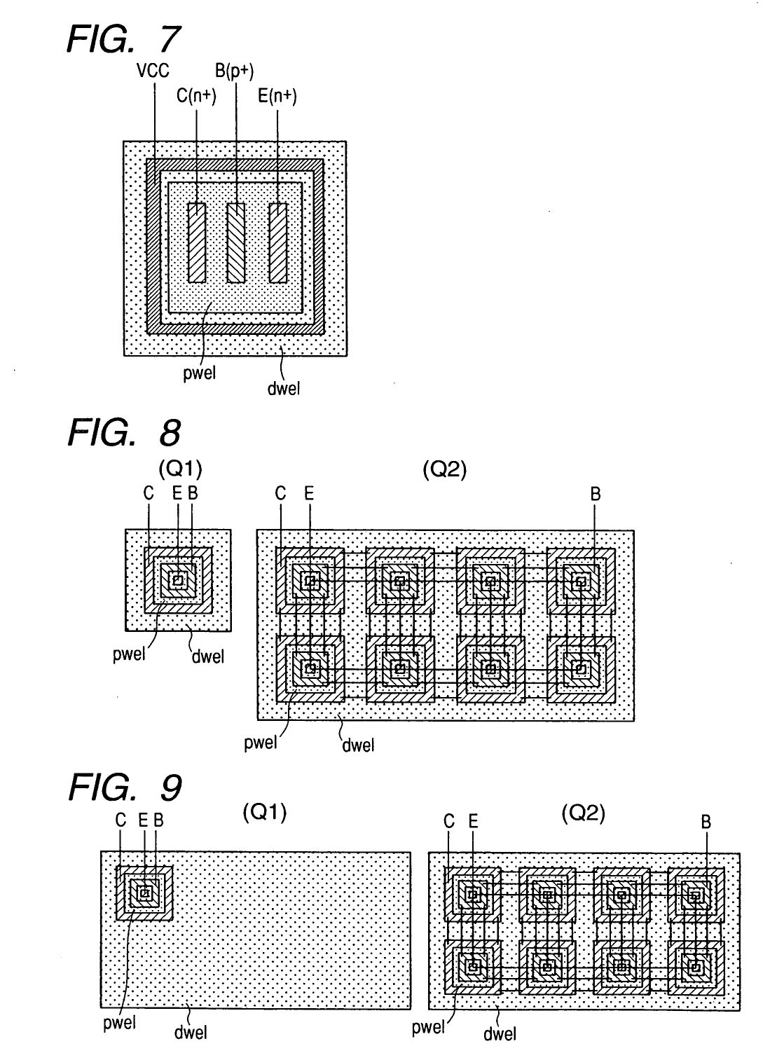

FIG. 7 is a layout view showing another embodiment of an npn-type bipolar transistor used in the reference voltage generating circuit according to the present invention. In this embodiment, in the same manner as the above-mentioned embodiment shown in FIG. 3, the base B (p+), the emitter E (n+) and the collector C (N+) are formed in the inside of the p-type well pwel, and the p-type well pwel is surrounded by the n-type deep well dwel which is separated by the power source voltage VCC. Further, this embodiment adopts the lateral structure in which the collector C (n+), the base B (p+) and the emitter E (n+) are arranged in parallel. The above-mentioned vertical structure of the CMOS shown in FIG. 3 and FIG. 4 and the above-mentioned layout of the bipolar transistor shown in FIG. 3 to FIG. 7 can be realized in any arbitrary combination.

In the reference voltage generating circuit of this embodiment, in the band gap generating part, a size ratio of the transistor Q1 and the transistor Q2 is set to 1:n. The transistors Q1, Q2 are formed on the separate n-type deep wells dwel.

FIG. 8 is a layout view showing one embodiment of npn-type bipolar transistors Q1, Q2 used in the reference voltage generating circuit according to the present invention. In this embodiment, although not particularly limited, an example in which the collector is formed in the vertical direction using the n-type deep well dwel is exemplified. In this embodiment, the peripheries of transistors Q1, Q2 are surrounded by the n-type deep well dwel. The deep well dwel of the transistor Q1 having the small size is formed in a small shape corresponding to the size of the transistor Q1. On the other hand, the n-type deep well dwel of the transistor Q2 having the large size is set to a size which corresponds to 8 pieces of the above-mentioned transistor Q1. In such a constitution, the size ratio of the transistors Q1, Q2 is set to 1:8.

FIG. 9 is a layout view showing another embodiment of npn-type bipolar transistors Q1, Q2 used in the reference voltage generating circuit according to the present invention. In this embodiment, different from the embodiment shown in FIG. 8, sizes of the n-type deep wells dwel which constitute collectors of two transistors Q1, Q2 are set equal to each other. In this manner, by setting the sizes of the n-type deep wells dwel which constitute the collectors equal to each other, influences of noises which propagate from the substrate due to capacitive coupling are set equal to each other thus canceling the noises as noises of the same phase.

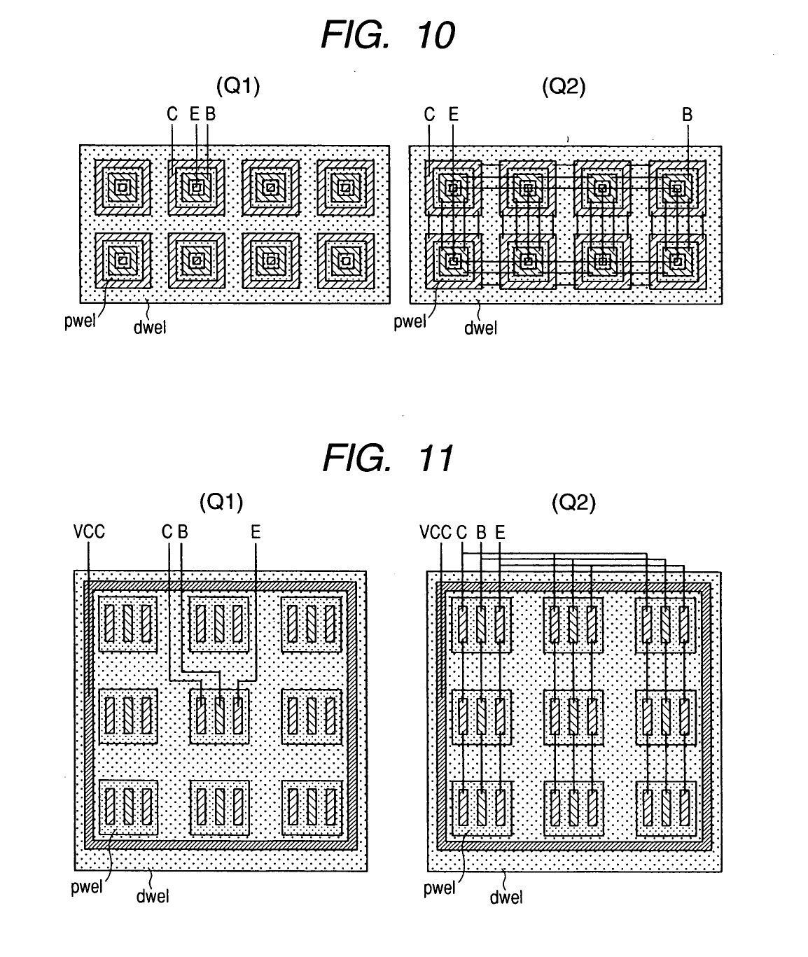

FIG. 10 is a layout view showing another embodiment of npn-type bipolar transistors Q1, Q2 used in the reference voltage generating circuit according to the present invention. In this embodiment, with respect to the transistors Q1, Q2, while setting the sizes of the n-type deep wells dwel equal to each other as in the case of the above-mentioned embodiment shown in FIG. 9, 8 pieces of transistors including dummy transistors are arranged in the deep well dwel in which the transistor Q1 having the small size is formed so as to have the same constitution as the transistor Q2. Then, by providing the wiring to one of 8 pieces of transistors, a size ratio of the transistors Q1, Q2 is set to the above-mentioned Q1/Q2=⅛. By providing the same pattern to the transistors Q1, Q2 in this manner, it is possible to reduce the influence of size irregularities in forming the transistors.

FIG. 11 is a layout view showing another embodiment of npn-type bipolar transistors Q1, Q2 used in the reference voltage generating circuit according to the present invention. This embodiment adopts the transistor having the lateral structure which mounts the base B, the emitter E and the collector C on the same p-type well pwel in the same manner as the constitution shown in FIG. 7. In the same manner as the transistors shown in FIG. 7, around the periphery of the n-type deep well dwel on which the transistor Q1 or the transistor Q2 is formed, the n+ region and the n-type well nwel (not shown in the drawing) for supplying the power source to stabilize the n-type deep well dwel are mounted. In this embodiment, a size ratio is set to Q1/Q2= 1/9, wherein the transistor Q1 is constituted of one transistor and eight dummy transistors. Here, when the number of the transistors Q2 is the power of integers such as 9 (3×3), by arranging the transistor Q1 at the center portion of the transistors arranged in the same number, the influence of the size irregularities can be further reduced.

Any shapes shown in the above-mentioned FIG. 8 to FIG. 11 are applicable to either one of the case which adopts the vertical structure in which the collector of the bipolar transistor is formed in the vertical direction using the n-type deep well and the case which adopts the lateral structure in which the collector of the bipolar transistor is formed on the same well.

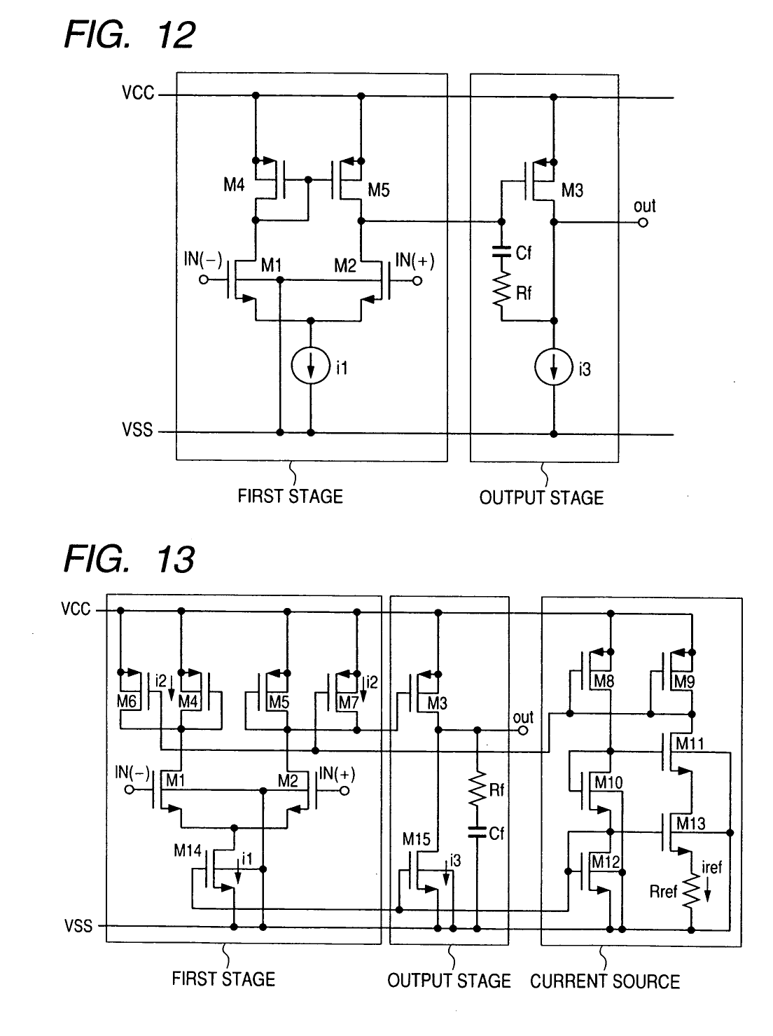

FIG. 12 is a circuit diagram showing one embodiment of a CMOS differential amplifier circuit used in the reference voltage generating circuit according to the present invention. The differential amplifier circuit is constituted of an initial stage part and an output stage part. The initial stage part is constituted of n-channel type differential MOSFETs M1, M2, a current source i1 which is provided between sources of the differential MOSFETs M1, M2 and a ground potential VSS of the circuit, and p-channel type current mirror MOSFETs M4, M5 which are provided between drains of the above-mentioned MOSFETs M1, M2 and a power source voltage VCC. The output stage part is constituted of a p-channel type amplifier MOSFET M3 which receives an output signal of the above-mentioned initial stage part at a gate thereof and receives the supply of a power source voltage VCC at a source thereof, and an inverting amplifier circuit which uses a current source i3 provided between a drain of the p-channel type amplifier MOSFET M3 and the ground potential VSS of the circuit as a load means. Between a gate and the drain of the MOSFET M3, a capacitor Cf and a resistance Rf which constitute a phase compensation circuit are provided.

As the difference MOSFETs M1 and M2, the above-mentioned n-channel type MOSFET shown in FIG. 3 or the like is used. To the p-type well pwel on which the n-channel type MOSFET shown in FIG. 3 is formed, the ground potential VSS of the circuit is applied as a bias voltage. On the other hand, when the n-channel type MOSFET described in the embodiment shown in FIG. 4 is used, since the p-type well pwel is separated from the substrate p-sub, it is possible to use the n-channel type MOSFET in a state that the source and the channel region (p-type well pwel) are connected with each other. In such a constitution, with respect to the MOSFETs M1, M2, the source potential and the potential of the channel region assume the same potential thus preventing the MOSFETs from being influenced by the substrate effect.

FIG. 13 is a circuit diagram showing another embodiment of a CMOS differential amplifier circuit used in the reference voltage generating circuit according to the present invention. In this embodiment, a current source is also shown in the drawing. In constituting the reference voltage generating circuit such that the reference voltage generating circuit is applied to the power source circuit, it is necessary to reduce the power consumption. Here, a gain of the amplifier is excessively elevated thus making the phase compensation difficult. This embodiment provides the circuit constitution which aims at the reduction of the power consumption, wherein the amplifier circuit is, in the same manner as the above-mentioned circuit shown in FIG. 12, constituted of an initial stage amplifier part for differential inputting using the n-channel MOSFETs M1, M2, an output stage which is formed of an inverting amplifier circuit which uses the p-channel amplifier MOSFET M3 and has a source thereof connected to a ground, and a current source which drives these parts.

As the current source, this embodiment uses, for supplying a microelectric current in a stable manner, a Widlar current source which generates a constant current Iref by reference to the gate-source voltage differences of the n-channel MOSFETs M12, M13 using the resistance Rref. By setting the n-channel MOSFETs M14, M15 in a current mirror state using the Widlar current source, bias currents i1, i3 of the initial stage and the output stage are determined. In setting a current value of the current i1 to a small value, to prevent a phenomenon that a gain of the amplifier of the initial stage is elevated and the phase compensation becomes difficult, current sources MOSFETs M6, M7 which allow a constant current i2 to flow in MOSFETs M4, M5 of a current mirror portion which constitutes factors for determining the gain respectively are connected in parallel to each other. The above-mentioned constant current Iref flows in the n-channel type MOSFETs M13, M11 and a p-channel MOSFET M9 in diode connection, wherein the MOSFET M9 and the MOSFET M8 as well as the above-mentioned MOSFETs M6, M7 assume a current mirror state and hence, the above-mentioned constant current i3 is generated. Accordingly, the phase compensation is facilitated. That is, besides the conventionally used mirror compensation, it is possible to perform the pole 0 compensation (Rf and Cf being connected to the output stage in series) which can be easily designed.

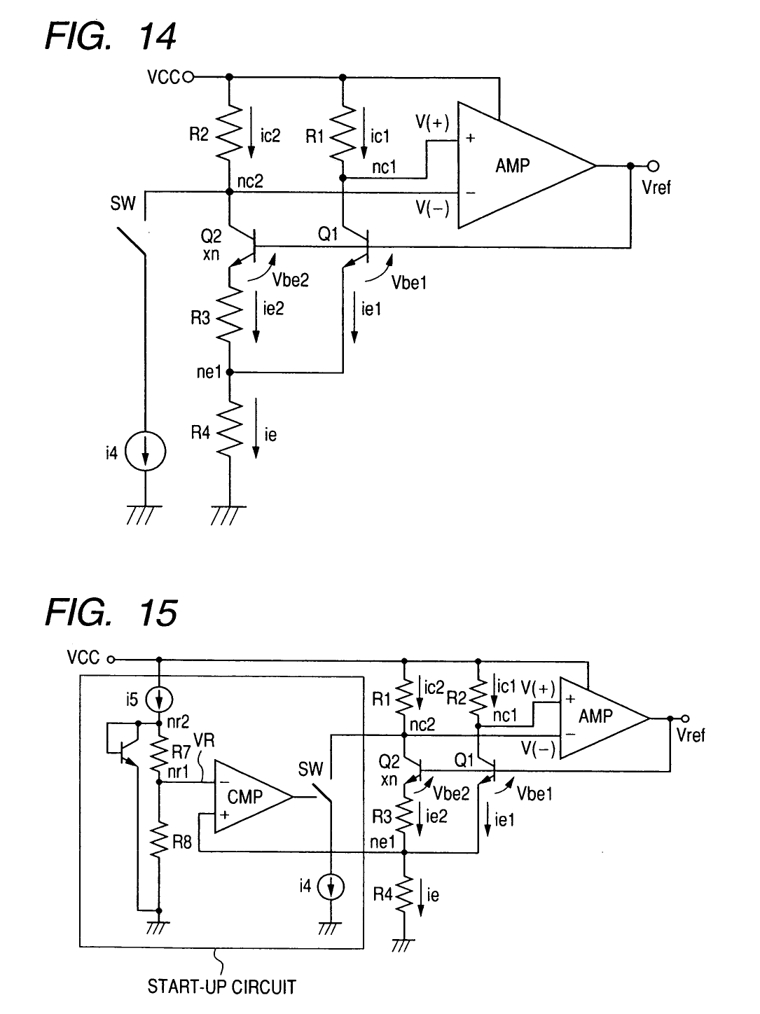

FIG. 14 is a circuit diagram showing one embodiment of the reference voltage generating circuit according to the present invention. In this embodiment, a start-up circuit is added to the circuit of the above-mentioned embodiment shown in FIG. 1. With respect to the reference voltage generating circuit, there may be a case that the output voltage Vref becomes stable at 0V at the time of starting such as the supply of power source voltage. To cope with such a case, the start-up circuit is provided and an operation of the circuit is started by forcibly supplying an electric current. With the provision of the start-up circuit, it is possible to surely generate the reference voltage at the time of supplying the power source and at the time of releasing a sleeping state. Even when disturbances are generated during the operation of the circuit, the circuit is restored readily thus generating the reference voltage in a stable manner.

The start-up circuit of this embodiment drives the reference voltage generating circuit such that a current source i4 is pulled out to a collector terminal nc2 (or nc1) of the transistor Q2 (or Q1), a potential of the collector terminal nc2 is lowered from the power source VCC and hence, an output voltage of the amplifier AMP is raised thus bringing the transistors Q1, Q2 into an operational state. A switch SW is provided for generating the above-mentioned current i4 at the time of supplying the power source or at the time of releasing the sleeping state thus allowing the current i4 to flow in the resistance R2 (or R1).

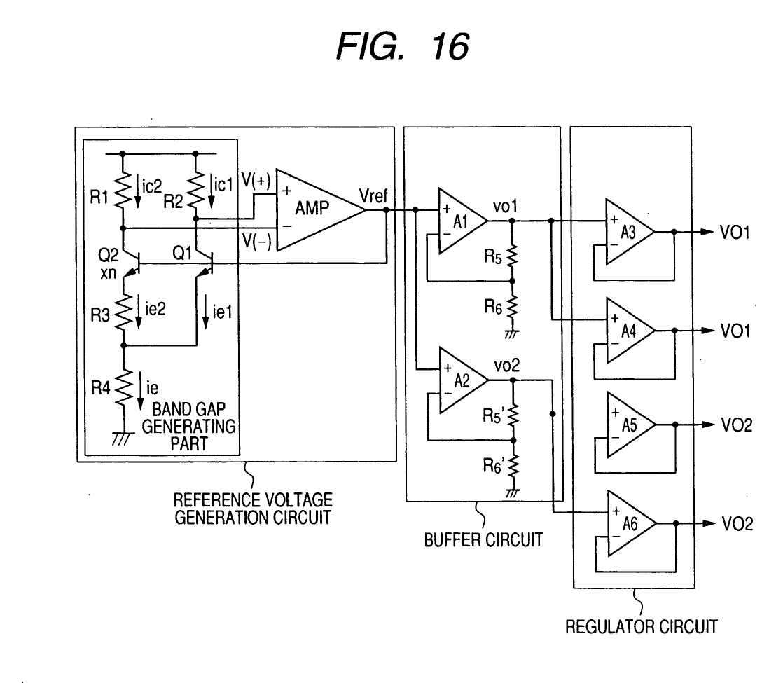

FIG. 15 is a circuit diagram showing one embodiment of the reference voltage generating circuit according to the present invention. In the drawing, a specific circuit of the start-up (start-up circuit) shown in FIG. 14 is shown. To an inversion input (−) of a voltage comparator CMP, a reference voltage VR is supplied. This reference voltage VR is a relatively low divided voltage which is obtained at a node nr1 by dividing a base-emitter voltage of the transistor in diode connection with resistances R7, R8. A current i5 which corresponds to a microelectric current iref which is generated as shown in FIG. 13 is made to flow in the above-mentioned transistor and resistances R7, R8. To a non-inversion input (+) of the voltage comparator CMP, a voltage of an emitter terminal nel of the transistor Q1 is applied. An output signal of the voltage comparator CMP generates a control signal of the switch SW, wherein the switch SW assumes an ON state when the output signal is at a low level and assumes an OFF state when the output signal is at a high level.

When an electric current does not flow in the bipolar portion of the reference voltage generating circuit, a potential of the emitter terminal nel of the transistor Q1 assumes 0V. Then, the above-mentioned reference voltage VR and the voltage of the emitter terminal nel of the transistor Q1 are compared. When the potential of the emitter terminal nel is lower than a potential of the node nr1 (VR), it is determined that the current does not flow in the bipolar portion and a detection that the current does not flow is made. In this state, an output signal of the voltage comparator CMP assumes the low level and hence, the above-mentioned switch SW assumes an ON state thus the operation of the circuit is started. When the transistors Q1, Q2 assume an operational state, the potential of the emitter terminal nel becomes higher than the potential of the node nr1 (VR) and a state that the electric current flows is detected. Accordingly, the output signal of the voltage comparator CMP is changed to the high level and hence, the above-mentioned switch SW assumes an OFF state. As described above, the reference voltage VR uses the forward voltage of the diodes which are connected in parallel and hence, even when the current i5 is changed, the potential VR of the nr2 is maintained at a constant value thus generating the reference voltage in a stable manner.

FIG. 16 is a circuit diagram showing one embodiment of a power source circuit using the reference voltage generating circuit according to the present invention. The reference voltage Vref which is generated by the reference voltage generating circuit according to the present invention shown in FIG. 1 has, on one hand, a level thereof converted to a desired power source voltage vo1 via a buffer circuit which is constituted of an amplifier A1 and feed back resistances R5, R6, and is outputted as internal voltages VO1, VO1 which are supplied to an internal circuit by way of a regulator circuit which is constituted of voltage follower circuits A3, A4. The above-mentioned reference voltage Vref has, on the other hand, a level thereof converted to a desired power source voltage vo2 which is different from the above-mentioned voltage vo1 via a buffer circuit which is constituted of an amplifier A2 and feed back resistances R5′, R6′, and is outputted as internal voltages VO2, VO2 which are supplied to other internal circuit via a regulator circuit which is constituted of voltage follower circuits A5, A6.

In this embodiment, a plurality of regulator circuits are provided corresponding to a plurality of respective functional blocks and are arranged in a scattered manner in the vicinity of the respective circuit modules (functional blocks) and hence, a line resistance value between the regulator circuit and the circuit module can be reduced whereby even when a relatively large load current flows in the circuit module, it is possible to prevent the lowering of a power source voltage level.

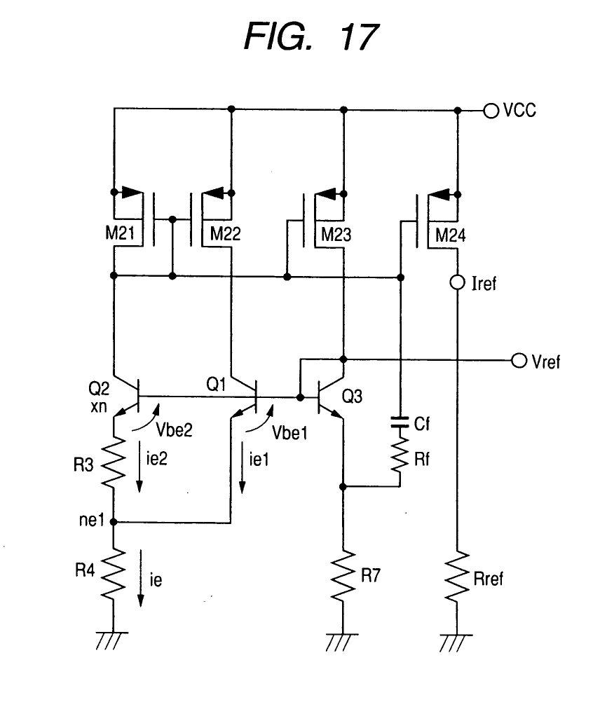

FIG. 17 is a circuit diagram showing another embodiment of the reference voltage generating circuit according to the present invention. In this embodiment, a current mirror circuit which is constituted of p-channel type MOSFETs M21, M22 is provided to the transistors Q1, Q2. Due to such a current mirror circuit, the same current flows in the transistors Q2, Q1 and hence, it is possible to set an emitter current density which is reversely proportional to a size ratio of the transistors Q1, Q2.

Further, by mirroring the MOSFET M23, the reference voltage Vref is obtained. Here, the transistor Q3 having a negative temperature coefficient is connected to obtain the reference voltage Vref which is not dependent on temperature by correcting a positive temperature coefficient of the resistance R7 provided to the emitter. A capacitor Cf and a resistance Rf are capacitor and a resistance for phase compensation. As a result, it is possible to generate the reference voltage Vref in the same manner as the above-mentioned embodiment shown in FIG. 1. Further, a current Iref which is obtained from a drain of a MOSSFET M24 is a constant current output, wherein an arbitrary voltage value is obtained by connecting a resistance Rref, for example. This embodiment can simplify the circuit compared to the embodiment shown in FIG. 1 or the like which uses the differential amplifier circuit.

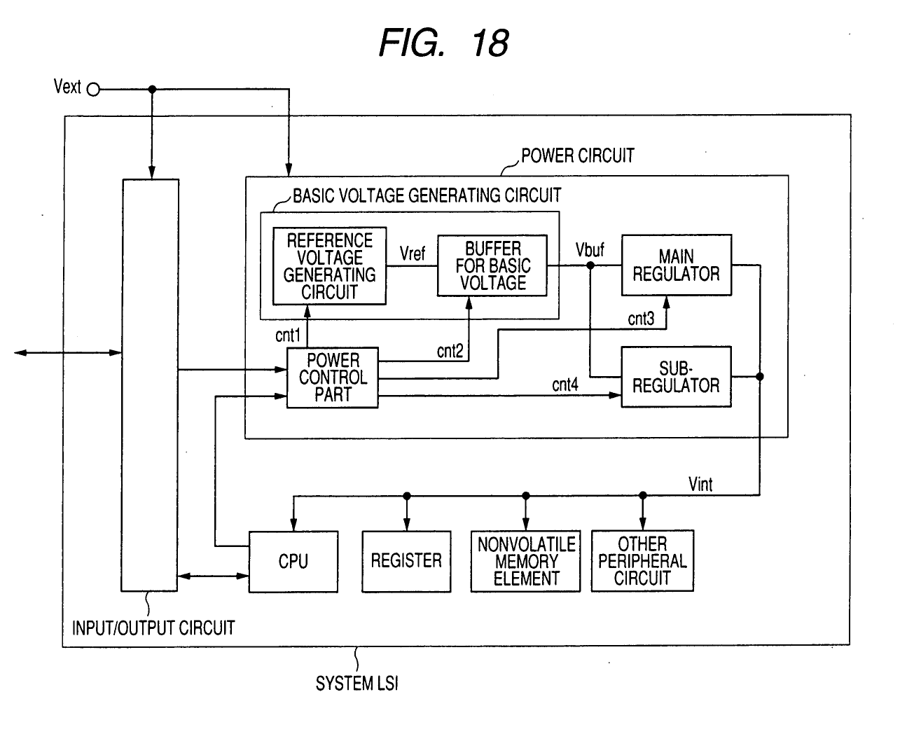

FIG. 18 is a whole block diagram showing one embodiment of a semiconductor integrated circuit device according to the present invention. This embodiment is, although not particularly limited, directed to a system LSI which incorporates a power source circuit therein. The power source circuit of this embodiment is constituted of a reference voltage generating circuit, a reference voltage buffer circuit, a series regulator (main power source: main regulator and standby power source: sub regulator) and a power source control part. The power source circuit is operated upon receiving a power source voltage from an external terminal Vext, forms an internal voltage Vint by reducing the voltage, and generates operational voltages for a CPU (center processing unit), resistances, non-volatile memory elements and other peripheral circuits which constitute the system LSI.

The power source control part performs the level conversion of the buffer circuit, the designation of activation of respective blocks and the like in response to control signals cnt1 to cnt4. An input/output circuit is provided to the above-mentioned semiconductor integrated circuit device. The input/output circuit includes an input circuit which is operated upon receiving a power source voltage supplied from the above-mentioned external terminal Vext and shifts a level of an external signal supplied from the external terminal such that the external signal conforms to a level of the internal circuit, and an output circuit which is formed of an internal circuit and converts the level of the signal to a signal level at which the signal is to be outputted from the external terminal.

As described above, the input/output circuit and the power source circuit are operated in response to the power source voltage supplied by the external terminal Vext. The input/output circuit performs the inputting/outputting of control signals of the power source circuit, the CPU and the like. The internal voltage Vint is an internal power source voltage outputted from the power source circuit and is supplied to the CPU, the registers, the non-volatile memory elements and other peripheral circuits. In this embodiment, by determining the internal power source voltage Vint based on the reference voltage Vref of the reference voltage generating circuit, it is possible to supply the constant internal power source voltage Vint without being influenced by external factors such as the change of the external power source voltage Vext, the temperature change or the like.

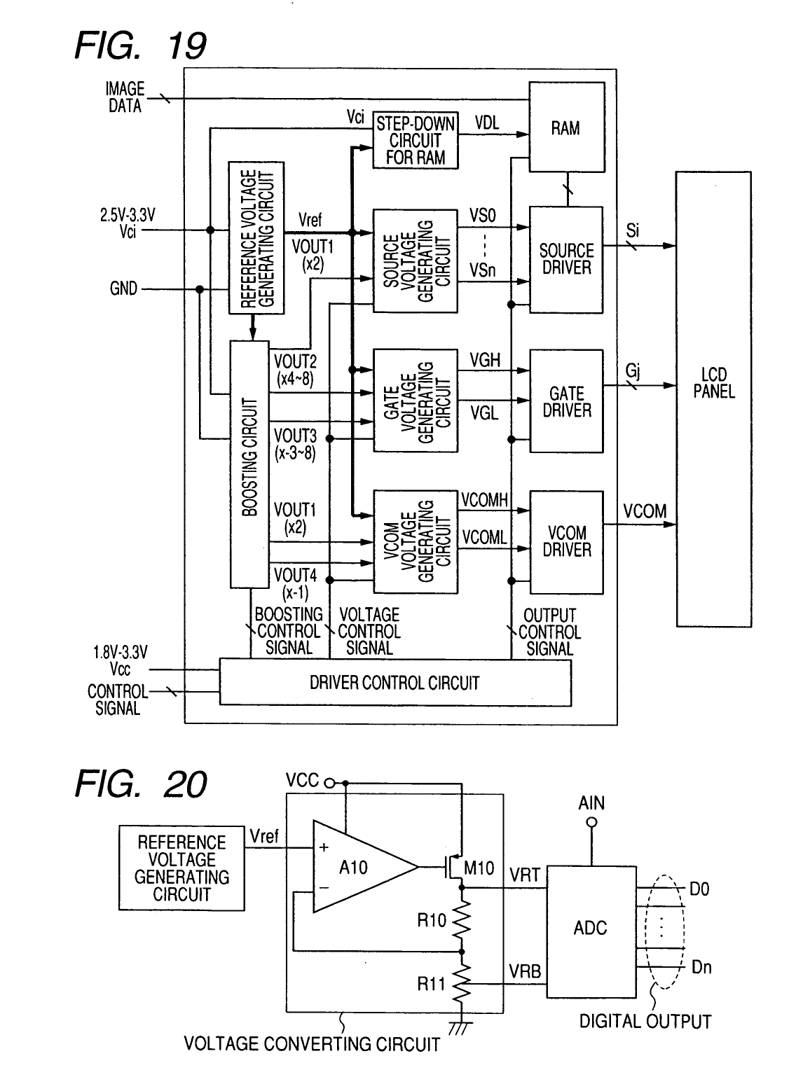

FIG. 19 is a whole block diagram showing another embodiment of a semiconductor integrated circuit device according to the present invention. In this embodiment, although not particularly limited, this embodiment is directed to an LCD driver circuit which incorporates a power source circuit therein. The LCD driver circuit of this embodiment includes the reference voltage generating circuit, a booster circuit, a RAM (random access memory) which stores display data, a source driver, a gate driver, a VCOM driver, various circuits for generating voltages for driving the respective drivers (a step-down circuit for RAM, a source voltage generating circuit, a gate voltage generating circuit, a VCOM voltage generating circuit) based on output voltages of the reference voltage generating circuit, and a driver control circuit.

The above-mentioned source voltage generating circuit generates gray scale voltages VS0 to VSn which correspond to the display data supplied to the pixel of the LCD (liquid crystal) panel. The gate voltage generating circuit generates selection/non-selection voltages VGH, VGL of the gate voltage for selecting the pixel. The VCOM voltage generates common voltages VCOMH, VCOML which are applied to a common electrode of a liquid crystal panel. The source driver outputs one voltage Si out of the gray scale voltages VS0 to VSn corresponding to the display data. The gate driver outputs, upon receiving the selection signal corresponding to the scanning operation, selection/non-selection signals Gj of the pixel. The VCOM driver changes over the voltage VCOM in response to a positive voltage and a negative voltage for performing the AC-driving of the liquid crystal pixels.

With respect to the LCD driver circuits of this embodiment, by applying voltages VDL, VS0 to VSn, VGH, VGL, VCOMH, VCOML and the like for driving the respective driver circuits based on the reference voltage Vref of the reference voltage generating circuit, it is possible to drive the respective drivers in a stable manner without performing the trimming to supply signals to the LCD panel and without being influenced by external factors such as the change of the external power source voltage Vci, the temperature change or the like.

FIG. 20 is a block diagram for explaining an application example of the reference voltage generating circuit according to the present invention. This embodiment is directed to an application example to an analogue/digital converter (ADC). Based on the reference voltage Vref which is formed by the reference voltage generating circuit according to the present invention, the voltage is converted into a desired voltage by a voltage converting circuit which is constituted of an amplifier circuit A10, an output MOSFET M10 and feedback resistances R10, R11 thus forming a maximum voltage VRT and a minimum voltage VRB, a plurality of reference voltages are formed by dividing the maximum voltage VRT and the minimum voltage VRB by a resistance divider circuit thus forming a plurality of reference voltages, and the reference voltages are compared with analogue inputs AIN with respect to levels thus forming digital outputs D0 to Dn. In this embodiment, it is unnecessary to supply the reference voltage Vref from the outside of a chip of the semiconductor integrated circuit device which incorporates the above-mentioned analogue/digital converter (ADC).

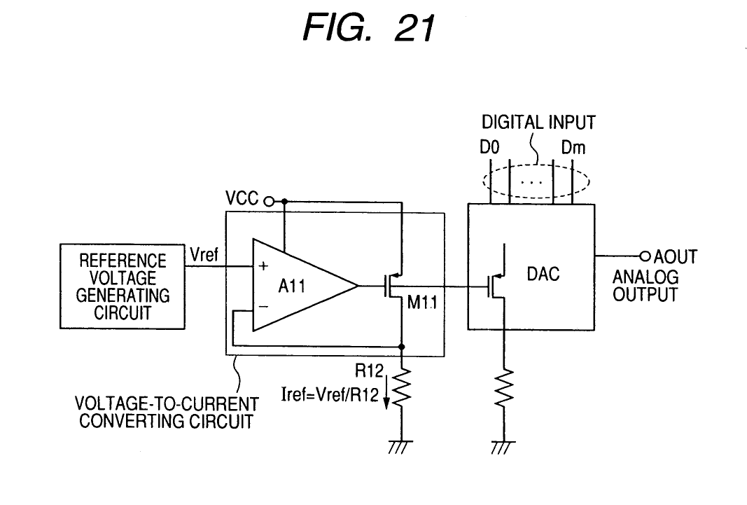

FIG. 21 is a block diagram for explaining another application example of the reference voltage generating circuit according to the present invention. This embodiment is directed to an application example of a digital/analogue converter (DAC). Based on the reference voltage Vref which is formed by the reference voltage generating circuit according to the present invention, a desired reference current Iref (Vref/R12) is formed by a voltage-current converting circuit which is constituted of an amplifier circuit A11, an output MOSFET M11 and a feedback resistance R12, electric currents having binary weights are formed based on the reference voltage Iref, and the electric currents are synthesized in response to the digital input signals D0 to Dn and are made to flow in the resistance thus obtaining an analogue output voltage AOUT. Also in this embodiment, it is unnecessary to supply the reference voltage Vref from the outside of the chip of the semiconductor integrated circuit device which incorporates the above-mentioned DAC therein.

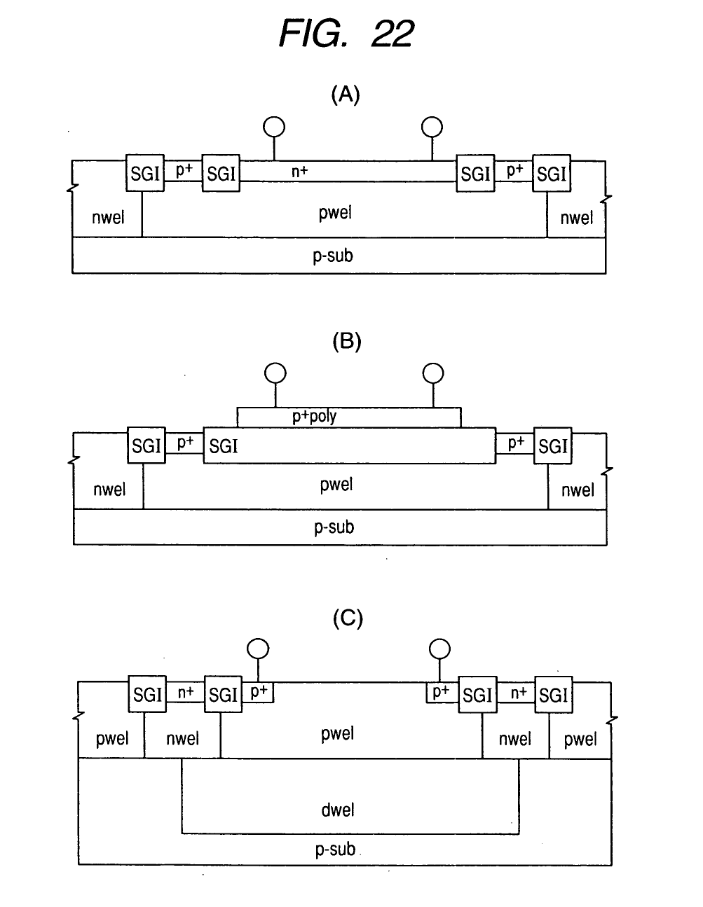

FIG. 22 is an element structural view showing one embodiment of a resistance element mounted in the semiconductor integrated circuit device according to the present invention. An example shown in FIG. 22(A) uses an n+ diffusion layer formed in the inside of the p-type well as a resistance. An example shown in FIG. 22(B) uses a poly-silicon layer p+ poly formed on a separation insulation layer SIG as a resistance element. An example shown in FIG. 22(C) uses a p-type wel pwel formed on an n-type deep well dwel as a resistance element. The p-type well pwel is electrically separated from the substrate p-sub by the above-mentioned deep well dwel and an n-type well nwel and an n+ region which are provided in the periphery of the deep well dwel. The resistance element of any one of the above-mentioned (A) to (C) may be constituted by a standard process (double well or triple well structure) of the CMOS.

The above-mentioned FIG. 22(A) uses the resistance value between n+ diffusions (or the resistance value between p+ diffusions in the inside of the n-type well), and to the p-well pwel which generates such a resistance value, a bias which is stabilized with the p+ diffusion is imparted. Accordingly, the high resistance can be obtained with a relatively small area, the accuracy of ratio of the resistance can be also made high, and the resistance element can be formed in the CMOS structure of the double wells or the triple wells.

A poly-silicon resistance shown in FIG. 22(B) makes use of a resistance value between p+ polysilicon terminals which are formed on a separation region SGI in the inside of the p-type well pwel (or a resistance value between n+ polysilicon terminals which are formed on a SIG in the inside of the n-type well nwel). This resistance can obtain a high resistance with a relatively small area, can increase the accuracy of ratio of the resistance, and can be formed in the CMOS structure of the double wells or triple wells.

FIG. 22(C) makes use of a resistance value between p-type well pwel terminals (terminals being formed on p+ diffusion) which are formed on the n-type deep well dwel. This resistance can obtain a high resistance with a relatively small area. Further, the resistance can be formed in the triple well CMOS structure.

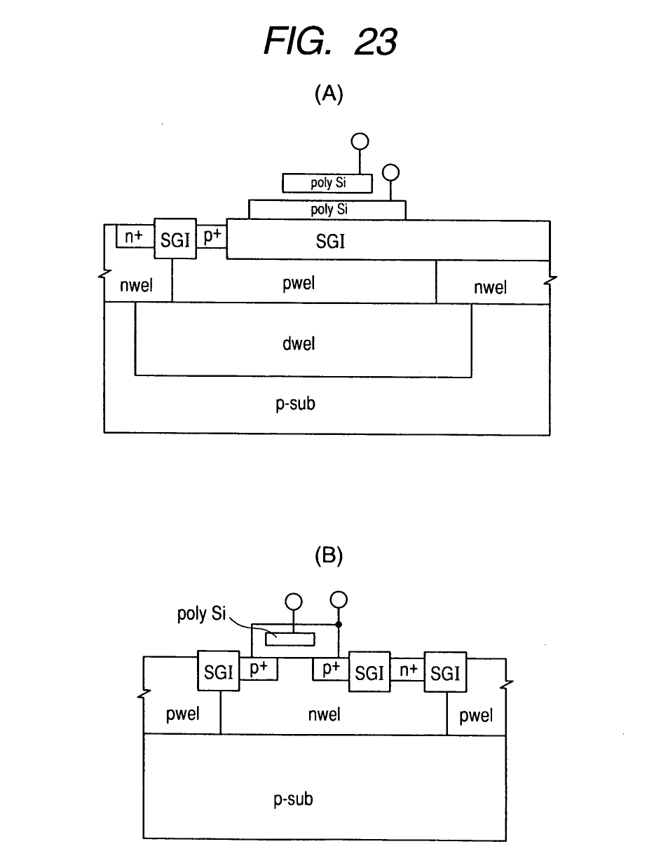

FIG. 23 is an element structural view showing one embodiment of a capacitance element mounted in the semiconductor integrated circuit device according to the present invention. In an example shown in FIG. 23(A), poly-silicon layers are formed in two layers with an interlayer insulation film sandwiched therebetween on an insulation layer SIG in the inside of a p-type well pwel. An example shown in FIG. 23(B) makes use of MOS capacitances. That is, this example makes use of the capacitance between a gate (poly-silicon) and a source, and the capacitance between drains (source and drain being short-circuited) of the p-channel MOSFET in the inside of the n-type well nwel. The n-type well nwel is made stable with a potential higher than a potential of a power source or a p-sub by way of an n+ layer on the well (capable of forming a MOS capacitance in the same manner as the nMOS in the inside of a p-wel on a n-sub). Both capacitance elements of the above-mentioned (A), (B) can be formed in a standard process of CMOS (double well or triple well structure).

Although the invention made by inventors of the present invention has been specifically explained based on the embodiments, the present invention is not limited to such embodiments and various modifications are conceivable without departing from the gist of the present invention. For example, besides the constitution which allows the same electric current to flow in the transistors Q1, Q2 and provides the current density difference based on the area ratio, the transistors Q1, Q2 may have the same size and an emitter current is made to flow in the transistors Q1, Q2 at a constant current ratio. Further, the area ratio and the current ratio may be combined. The present invention is widely applicable to a constant voltage generating circuit which is mounted on the semiconductor integrated circuit device which is formed by the CMOS process or the semiconductor integrated circuit device which incorporates the reference voltage generating circuit and is formed by the CMOS process.

1. A voltage generating circuit comprising:
a first transistor which allows a first current to flow in an emitter thereof;
a second transistor which allows a second current which has a current density larger than a current density of the emitter of the first transistor to flow in an emitter thereof;
a first resistance which is provided between the emitter of the first transistor and the emitter of the second transistor;
a second resistance which is provided between the emitter of the second transistor and a ground potential of the circuit;
a third resistance which is provided between a collector of the first transistor and a power source voltage;
a fourth resistance which is provided between a collector of the second transistor and the power source voltage; and
a differential amplifier circuit having the CMOS constitution which forms an output voltage upon receiving a collector voltage of the first transistor and a collector voltage of the second transistor and, at the same time, supplies the output voltage to bases of the first transistor and the second transistor in common, wherein
the first transistor and the second transistor are constituted by making us of a semiconductor region formed in a process of a CMOS circuit which constitutes the differential amplifier circuit.

2. A voltage generating circuit according to claim 1, wherein the third resistance and the fourth resistance are configured to possess a same resistance value.

3. A voltage generating circuit according to claim 2, wherein an emitter area of the first transistor is set larger than an emitter area of the second transistor.

4. (canceled)

5. A semiconductor integrated circuit device including a reference voltage generating circuit which comprises:
a first transistor which allows a first current to flow in an emitter thereof;
a second transistor which allows a second current which has a current density larger than a current density of the emitter of the first transistor to flow in an emitter thereof;
a first resistance which is provided between the emitter of the first transistor and the emitter of the second transistor;
a second resistance which is provided between the emitter of the second transistor and a ground potential of the circuit which is supplied from an external terminal;
a third resistance which is provided between a collector of the first transistor and a power source voltage which is supplied from an external terminal;
a fourth resistance which is provided between a collector of the second transistor and the power source voltage; and
a differential amplifier circuit having the CMOS constitution which forms an output voltage upon receiving a collector voltage of the first transistor and a collector voltage of the second transistor and, at the same time, supplies the output voltage to bases of the first transistor and the second transistor in common, wherein
the first transistor and the second transistor are constituted by making use of a semiconductor region formed in a process of a CMOS circuit which constitutes the differential amplifier circuit.

6. A semiconductor integrated circuit device according to claim 5, wherein the semiconductor integrated circuit device includes a CMOS circuit which is constituted of a second conductive-type well region and a first conductive-type well region which are formed on a first conductive-type semiconductor substrate, a first conductive-type MOSFET which is formed on the second conductive-type well region, and a second conductive-type MOSFET which is formed on the first conductive-type well region, and
the first transistor and the second transistor which constitute the reference voltage generating circuit are formed of a bipolar transistor having the lateral structure which uses diffusion layers which are formed in a step for forming source and drain diffusion layers of the second conductive-type MOSFET which constitutes the CMOS circuit as the collector and the emitter and is operated using the first conductive-type well region on which the diffusion layers which constitute the collector and the emitter are formed as a base.

7. A semiconductor integrated circuit device according to claim 5, wherein the semiconductor integrated circuit device includes the CMOS circuit which is constituted of the second conductive-type well region and the first conductive-type well region which are formed on the first conductive-type semiconductor substrate, the first conductive-type MOSFET which is formed on the second conductive-type well region, the second conductive-type MOSFET which is formed on the first conductive-type well region, and the second conductive-type well region having a depth for electrically separating the first conductive-type well region on which the second conductive-type MOSFET is formed from the first conductive-type semiconductor substrate, and
the first transistor and the second transistor are formed of a bipolar transistor having the vertical structure which uses a second conductive diffusion layer which is formed in a step for forming source and drain diffusion layers of the first conductive-type MOSFET which constitutes the CMOS circuit as the emitter, uses the first conductive-type well region on which the second conductive-type diffusion layer which constitutes the emitter is formed as a base, and uses the second conductive-type well region having a depth which is provided for electrically separating the first conductive-type well region which constitutes the base from the first conductive semiconductor substrate as a collector.

8. A semiconductor integrated circuit device according to claim 5, wherein
the semiconductor integrated circuit device includes a CMOS circuit which is constituted of a second conductive-type well region and a first conductive-type well region which are formed on a second conductive-type semiconductor substrate, a first conductive-type MOSFET which is formed on the second conductive-type well region, and a second conductive-type MOSFET which is formed on the first conductive-type well region, and
the first transistor and the second transistor which constitute the reference voltage generating circuit are formed of a bipolar transistor having the lateral structure which uses diffusion layers which are formed in a step for forming source and drain diffusion layers of the second conductive-type MOSFET which constitutes the CMOS circuit as the collector and the emitter and is operated using the first conductive-type well region on which the diffusion layers which constitute the collector and the emitter are formed as a base.

9. A semiconductor integrated circuit device according to claim 6, wherein the first conductive-type is a p-type and the second conducive-type is an n-type, and
a power source voltage which is supplied from the external terminal is a positive power source voltage.

10. A semiconductor integrated circuit device according to claim 9, wherein the second transistor is constituted of one transistor and the first transistor is constituted by connecting a plurality of unit transistors corresponding to the second transistor in parallel.

11. A semiconductor integrated circuit device according to claim 10, wherein the first transistor is configured such that the plurality of unit transistors are formed on the well regions having the same depth, and one of the plurality of unit transistors which are formed to have the same constitution as the first transistor is used as the second transistor.

12. A semiconductor integrated circuit device according to claim 11, wherein
the semiconductor integrated circuit device further includes:
a power source circuit which generates an internal voltage different from a power source voltage which is supplied from the external terminal upon receiving a reference voltage formed by the reference voltage generating circuit;
an internal circuit which is operated by the power source circuit;
an input circuit which is operated upon receiving a power source voltage supplied from the external terminal, performs a level conversion upon receiving an input signal supplied from an external terminal and transmits the signal to the internal circuit; and
an output circuit which is operated upon receiving a power source voltage supplied from the external terminal, performs a level conversion upon receiving a signal generated by the internal circuit, and forms an output signal to be outputted from the external terminal, wherein
the differential amplifier circuit is constituted of a P-channel MOSFET and an N-channel MOSFET which are formed in the same process as MOSFETs which constitute the input circuit and the output circuit which are operated upon receiving a power source voltage supplied from the external terminal.

13. A semiconductor integrated circuit device according to claim 11, wherein
the internal voltage is formed by reducing the power source voltage supplied from the external terminal, and
the internal circuit is formed with a minimum forming size of a CMOS processing.

14. A semiconductor integrated circuit device according to claim 11, wherein
the power source circuit includes a booster circuit and a negative voltage generating circuit which are operated at a constant voltage formed by using the reference voltage, and
a voltage which is formed by the booster circuit and the negative voltage generating circuit is outputted as a gate drive voltage for driving liquid crystal, a source drive voltage corresponding to image data, and a liquid crystal common electrode drive voltage.

15. A semiconductor integrated circuit device according to claim 7, wherein the first conductive-type is a p-type and the second conducive-type is an n-type, and
a power source voltage which is supplied from the external terminal is a positive power source voltage.

16. A semiconductor integrated circuit device according to claim 8, wherein the first conductive-type is a p-type and the second conducive-type is an n-type, and
a power source voltage which is supplied from the external terminal is a positive power source voltage.

17. A semiconductor integrated circuit device according to claim 15, wherein the second transistor is constituted of one transistor and the first transistor is constituted by connecting a plurality of unit transistors corresponding to the second transistor in parallel.

18. A semiconductor integrated circuit device according to claim 16, wherein the second transistor is constituted of one transistor and the first transistor is constituted by connecting a plurality of unit transistors corresponding to the second transistor in parallel.
